(19) United States
(12) Patent Application Publication
(10) Pub. No.: US 2011/0170177 A1
(43) Pub. Date: Jul. 14, 2011

(54) MOLDING FOR OPTICAL PURPOSES, PARTICULARLY FILTER RING OR LENS HOLDER

(76) Inventors: Manfred Meissner, Dresden (DE); Frank Ende, Dresden (DE)

(21) Appl. No.: 13/120,228

(22) PCT Filed: Sep. 10, 2009
(86) PCT No.: PCT/DE2009/050050

§ 371 Date: Mar. 22, 2011

(30) Foreign Application Priority Data
Sep. 22, 2008 (DE) 102008048333.8

(51) Int. Cl. G02B 7/00; B29D 11/00; G02B 5/20; G02B 5/30; G02B 7/02

(52) U.S. Cl. 359/361; 264/1.1; 359/492.01; 359/830; 359/829

(57) ABSTRACT

The invention relates to a molding for optical purposes (1), consisting of a disk-shaped optical construction element (2) made of glass as well as a mounting (3). According to the invention, the mounting (3) is a one-piece overmolded mounting (3) made of a rigid plastic material, which positively encloses the disk-shaped optical construction element.

The invention relates to a molding for optical purposes, comprising a disk-shaped optical construction element made of glass, such as a lens, a filter, or a lens hood, as well as a mounting. In particular, the invention relates to a close-up lens or a close-up filter, in particular a filter ring.

In the photographic practice it is often required that additional lenses, filters, and lens-hoods are used that are temporarily attached to the mounting of the object lens of photographic cameras.

Typically, these additional lenses, filters, or lens hoods exhibit a ring-shaped mounting made of metal. The mounting often possesses a female and a male thread. By means of the male thread formed at the outer circumferential surface of the ring the mounting can be screwed into a complementary female thread formed at the object lens. The female thread of the mounting formed at the inner circumferential surface of the mounting allows it to attach a further similar mounting there carrying another lens etc. By the threaded connections the user is allowed to attach various optical systems to the object lens according to his needs.

Nowadays used ring-shaped mountings consist of several component parts, namely an outer ring, an inner ring screwed into the outer ring and a snap ring. The outer ring has at its inner circumferential surface a concentrically peripheral rib formed in about half the axial height of the ring. On this rib the disk-shaped filter (or another optical element) is placed which is held by means of the snap ring in its position. Here, the snap ring is held by the inner ring screwed into the outer ring and having at its front side a concentrically peripheral rib extending towards the axis of rotation of the mounting and pressing the snap ring against the disk-shaped filter. Here, the inner ring is not completely screwed into the outer ring, but extends axially beyond it. The outer surface of the projecting part of the inner ring carries the male thread of the mounting that permits the attachment to the object lens mounting. At the inner circumferential surface of the outer ring bordering on the side of the rib which is faced away from the filter disk the female thread of the mounting is formed that permits the attachment of a further similar mounting.

The components of said mountings are made of metal, as a rule brass that has an—almost always black—paint coating.

The production of such close-up lenses or filters is costly. On the one hand, the production of the individual components and on the other hand, the assembling of the components and the optical construction element is required what necessitates several steps. Moreover, the paint coating tends to peel off after repeated use of the close-up lens or the close-up filter, at first in the area of the threads and then also in the remaining exposed areas of the mounting. In addition, the displacement of the optical construction element is not excluded.

From AT 140645 a mounting for close-up lenses, filters, or the like is known that is formed as one piece of an elastically expansible material. The mounting has in its inner circumferential surface a concentrically peripheral groove into which the lens can be put what is permitted by the elastic properties of the elastically expansible material. Due to its elastic properties the mounting can be put on the object lens mounting.

However, a mounting made of an elastic material is suitable for screwing with the object lens mounting on the one hand and with another similar mounting on the other hand. Moreover, it cannot be ensured with such a mounting that the close-up lens, the close-up filter etc. are actually arranged on the optical axis of the object lens what can interfere with the quality of photographs.

DE 196 15 371 C2 describes a glass plate, especially for hobs, that is injected in an overmolded plastic mounting frame. Here, the mounting frame is shrunk tightly on the glass plate for which a shrink-receiving element is provided that is arranged between the mounting frame and the overmolded glass body. The shrink-receiving element is inter alia to prevent breaking of the glass plate since it can absorb the tensions forming in the normal use of the glass plate.

However, the shrink-receiving elements can also lead to the displacement of the lens or the filter since it can hardly be ensured that the shrinkage is consistent.

Object of the invention is to eliminate the disadvantages of the prior art. In particular, there is provided a molding for optical purposes, having an optical construction element and a mounting which can be produced with low cost, ensures a precise and unchangeable position of the optical construction element in the mounting, and permits a precise attachment on the object lens.

This object is achieved by the features of claims 1 and 10. Suitable developments of the inventions result from the features of claims 2 to 9 and 10 to 12.

In accordance to the invention there is provided a molding for optical purposes, consisting of a disk-shaped optical construction element made of glass as well as a one-piece overmolded mounting made of a rigid plastic material, which encloses the disk-shaped optical construction element. The mounting positively encloses the disk-shaped optical construction element. Preferably, the mounting is ring-shaped.

The disk-shaped optical construction element is made of glass. The construction element should have high mechanical strength to achieve the desired optical properties and the required mechanical stability.

For example, the disk-shaped optical construction element can be a filter, in particular a polarization filter or UV barrier filter; or a lens. Preferably, the disk-shaped optical construction element is circular cylindrical.

A preferred molding for optical purposes according to the invention is a close-up filter, in particular a filter ring.

Compared to the state of the art the molding according to the invention can be produced in one operation since the mounting of the molding must not be composed of component parts. Furthermore, the production of component parts is prevented since their threads must be matched up. Because of the overmolding of the disk-shaped optical construction element and the positive connection between the mounting and the optical construction element slipping of the optical construction element is prevented in any circumstances. Therefore, a high stability of the entire molding is achieved.

The plastic material can be colored as desired. Thus, paint coating of the mounting or its components is not necessary. That is the reason why no paint can peel off.

In a preferred embodiment a male thread is formed at the outer circumferential surface of the ring-shaped mounting and a female thread is formed at the inner circumferential surface of the ring-shaped mounting.

Preferably, there are further formed a first concentrically peripheral rib and a second concentrically peripheral rib spaced from the first peripheral rib at the inner circumferential surface of the ring-shaped mounting, wherein the disk-shaped optical construction element is arranged between the first rib and the second rib.

Preferably, the second rib borders on the first front side of the ring-shaped mounting, wherein the first rib is spaced both from the first front side and from the second front side of the ring-shaped mounting. Here, the area of the inner circumferential surface of the ring-shaped mounting located between the first rib and the second rib of the ring-shaped mounting should have the female thread. At the outer circumferential surface there is preferably formed a concentrically peripheral groove or tapering, wherein the circumferential surface of the groove or tapering exhibits the male thread.

Preferably, the plastic material is a thermoplastic polymer, preferably polyamide or polyamide 6, in particular glass bead-filled polyamide 6. The plastic material should possess sufficient mechanical strength and elasticity as well as low cross sections to compensate and/or absorb high tensions. Preferably, the plastic material is elastic at ambient temperatures between −25 and +85° C. such that different temperature coefficients between glass and plastic material can be compensated. In this way, differential tensions are compensated by the elasticity of the plastic material.

The connection between the disk-shaped construction element and the mounting is secured by positive joint and shrinking.

In accordance to the invention there is further provided a method for the preparation of the molding for optical purposes according to the invention, comprising the following steps:
(a) inserting the disk-shaped optical construction element into the injection mold of an injection molding machine;
(b) fixing the disk-shaped optical construction element in the injection mold by means of tool elements contacting the disk-shaped optical element at its surface sides, wherein the construction element is exposed at its circumferential surface;
(c) injecting the plastic material into the cavity that is surrounded by the tool elements and the disk-shaped optical construction element; and
(d) curing the plastic material to form the one-piece overmolded mounting.

Subsequently, the finished molding can be removed from the injection molding machine.

Unevennesses in the surface sides of the disk-shaped optical construction element should be compensated by means of the tool elements. For that, preferably by means of the clamping pressure, with which the injection mold is closed after the disk-shaped optical construction element has been inserted, the position of the tool elements contacting the disk-shaped optical construction element is determined, wherein said tool elements are arranged such that the unevennesses in the surface sides of the optical construction element are compensated.

In one embodiment of the method for the preparation of the filter ring according to the invention a device (also referred to as handling) takes a filter glass disk from a magazine, wherein the position of the filter glass disk to the handling is precisely fixed. Subsequently, the handling positionally accurate and prefixed hands over the filter glass disk (now referred to as insert) into the cavity of an opened injection mold. The injection mold takes over the insert by suction via vacuum after which the handling is removed from the opened injection mold. Then, the injection mold is closed and the clamping pressure is build up, wherein the tool elements compensate the thickness tolerance of ca. +/−0.2 mm of the filter glass disk. Here, the filter glass disk remains fixed in its position without radially touching the wall of the injection mold. The tool elements, in particular mold inserts, sliders, and thread de-spindling, form the contour of the plastic mounting at the filter glass disk. Then, the cavity surrounded by the tool elements and the filter glass disk is filled with the plastic material via the sprue system of the injection molding machine. After cooling the plastic mass the injection mold is opened and the molding obtained is exposed. When opening, the sprue is automatically removed from the molding to obtain the filter ring. The overmolded filter glass disk is taken out of the injection mold by a handling.

In the following, the invention is explained in more detail with respect to an example, that is not intended to limit the invention, with reference to the drawings. Here,

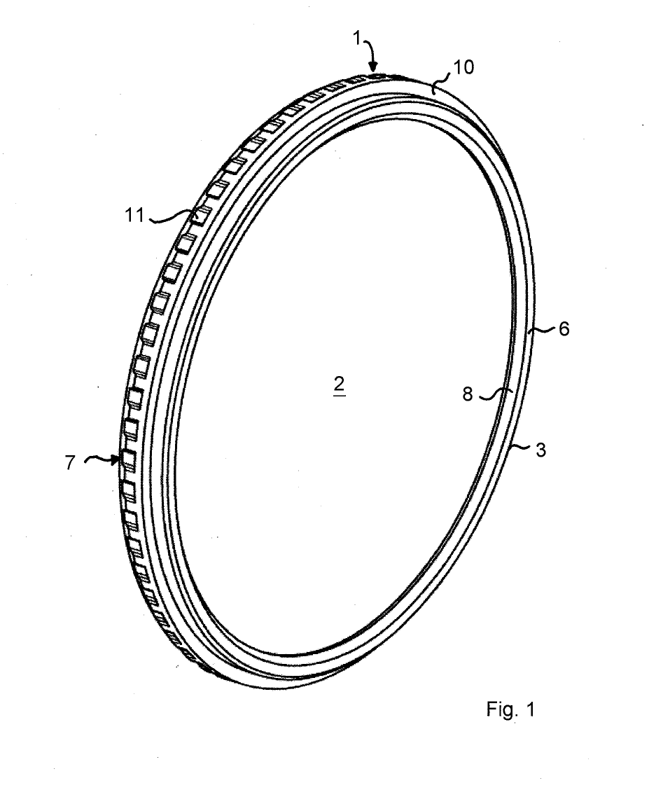

FIG. 1 shows a perspective representation of an embodiment of a filter ring according to the invention;

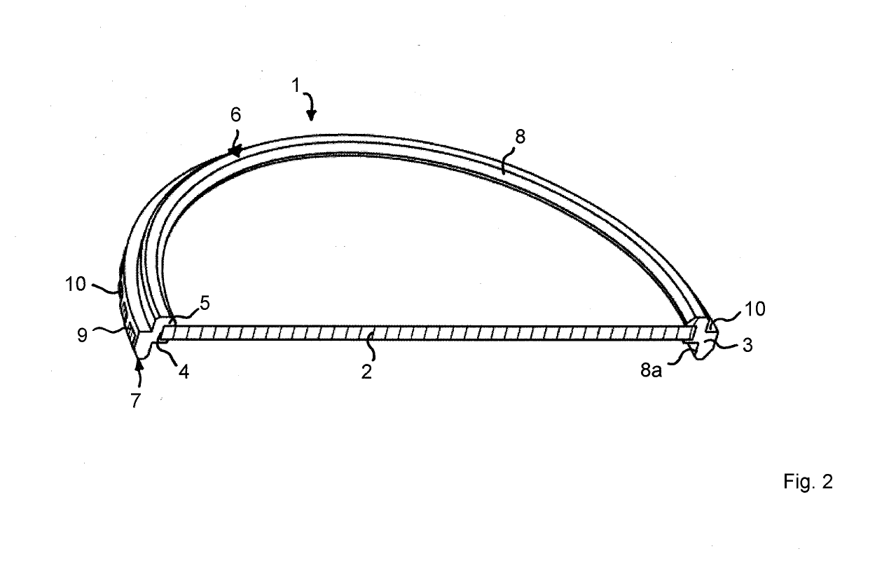

FIG. 2 shows a sectional view of the filter ring shown in FIG. 1,

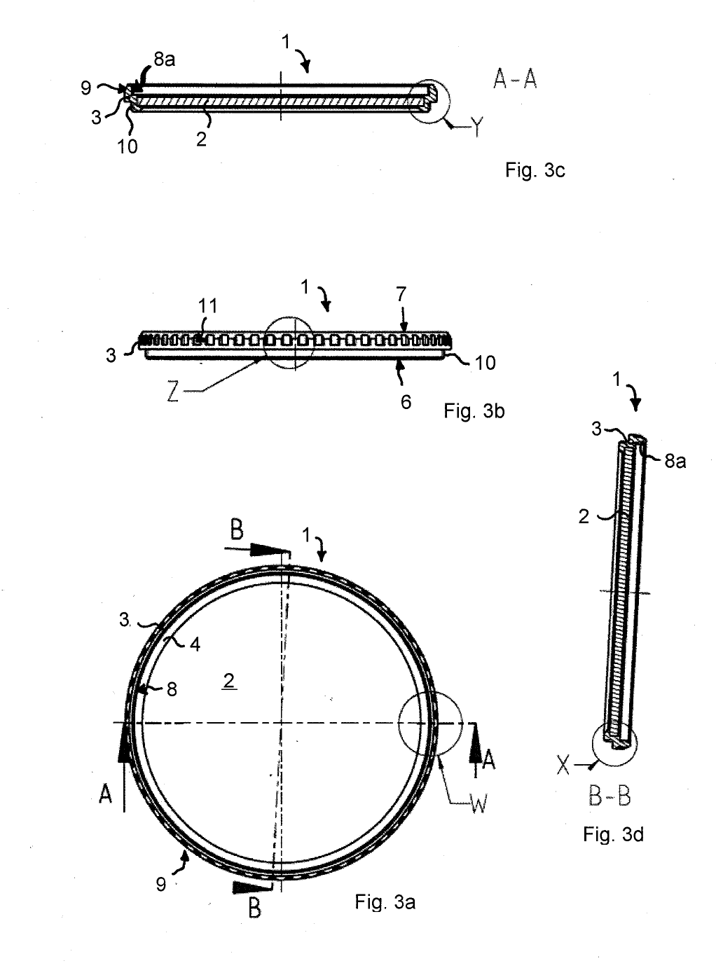

FIG. 3a shows a front view of the filter ring shown in FIG. 1;

FIG. 3b shows a side view of the filter ring shown in FIG. 3;

FIG. 3c shows a section view of the filter ring shown in FIG. 3 along the line A-A;

FIG. 3d shows a section view of the filter ring shown in FIG. 3 along the line B-B;

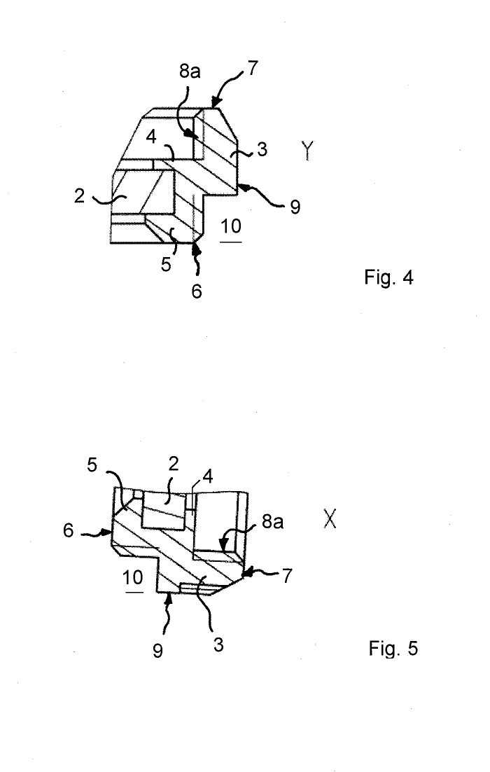

FIG. 4 shows an enlarged section view of cut-out Y of FIG. 3c;

FIG. 5 shows an enlarged section view of cut-out X of FIG. 3d;

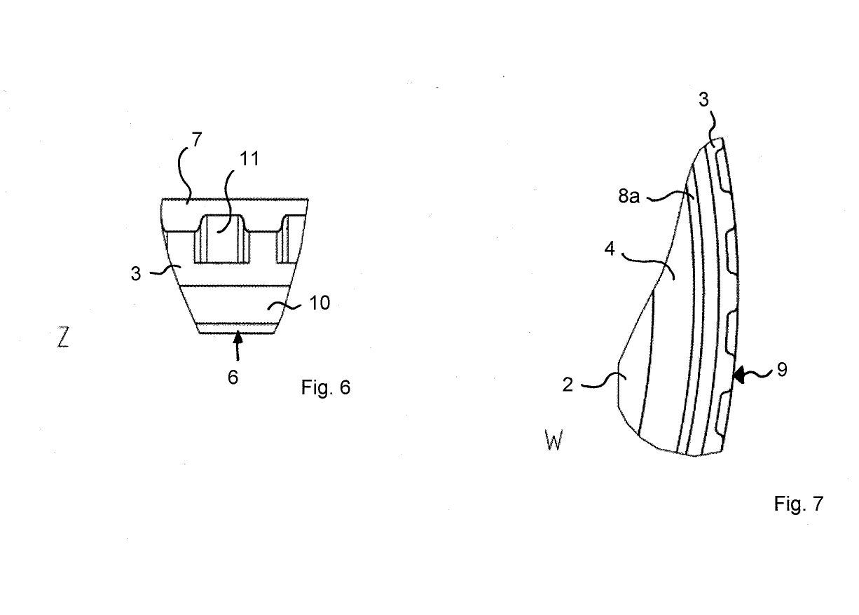

FIG. 6 shows an enlarged cut-out Z of FIG. 3b; and

FIG. 7 shows an enlarged cut-out W of FIG. 3a.

According to the figures the filter ring 1 according to the invention consists of a circular cylindrical filter glass disk 2 and a one-piece overmolded mounting 3 enclosing the filter glass disk 2. The mounting consists of polyamide 6 filled with 30% by weight glass beads (marketed under the designation “Akromid B3 GK 30” by Akro-Plastic GmbH, Niederzissen, DE).

The mounting 3 is ring-shaped. At the inner circumferential surface of the ring-shaped mounting 3 are formed a first concentrically peripheral rib 4 and a second concentrically peripheral rib 5 that is spaced from the first peripheral rib 4. The second rib 5 borders on the first front side 6 of the ring-shaped mounting, whereas the first rib 4 is spaced both from the first front side 6 and the second front side 7 of the ring-shaped mounting 3 and is located about half the height with respect to the axial extent of the mounting 3. The filter glass disk 2 is arranged between the first rib 4 and the second rib 5.

In the area 8a of the inner circumferential surface 8 of the ring-shaped mounting 3 that is located between the first rib 4 and the second front side 7 of the ring-shaped mounting 3 there is formed a female thread to connect the mounting 3 to a further close-up lens or a further close-up filter, for example a filter ring. At the outer circumferential surface 9 there is preferably formed a concentrically peripheral tapering 10 the concentrically peripheral circumferential surface of which exhibits the male thread by means of which the molding 1 can be screwed into the mounting of a object lens.

Also, at the outer circumferential surface 9 there may be provided a peripheral corrugation 11 to facilitate screwing in and out of the molding 1 from the mounting of the object lens.

### LIST OF REFERENCE NUMBERS

1 filter ring
2 filter glass disk
3 mounting
4 first rib
5 second rib
6 first front side
7 second front side
8 inner circumferential surface
8a area of the inner circumferential surface
9 outer circumferential surface
10 tapering
11 corrugation

1-12. (canceled)

13. A molding for optical purposes comprising:
a disk-shaped optical construction element (2) made of glass;
a ring-shaped one-piece overmolded mounting (3) made of a rigid plastic material that encloses the disk-shaped optical construction element (2); and,
wherein the disk-shaped optical construction element is one of circular cylindrical and lenticular.

14. The molding according to claim 13 wherein the disk-shaped optical construction element exhibits unevennesses in its surface sides.

15. The molding according to claim 13 wherein the mounting (3) positively encloses the disk-shaped optical construction element (2).

16. The molding according to claim 15 wherein at the outer circumferential surface (9) of the ring-shaped mounting (3) a male thread is formed and at the inner circumferential surface (8) of the ring-shaped mounting (3) a female thread is formed.

17. The molding according to claim 15 wherein:
at the inner circumferential surface (8) of the ring-shaped mounting (3) there are formed a first concentrically peripheral rib (4) and a second concentrically peripheral rib (5) that is spaced from the first peripheral rib (4); and,
the disk-shaped optical construction element (2) is arranged between the first rib (4) and the second rib (5).

18. The molding according to claim 17 wherein:
the second rib (5) borders on the first front side (6) of the ring-shaped mounting (3);
the first rib (4) is spaced from both the first front side (6) and the second front side (7) of the ring-shaped mounting (3); and,
an area (8a) of the inner circumferential surface (8) of the ring-shaped mounting (3) exhibits a female thread that is located between the first rib (4) and the second front side (7) of the ring-shaped mounting (3).

19. The molding according to claim 16 wherein;
at the outer circumferential surface (9) a concentric peripheral tapering (10) is formed; and,
the circumferential surface of the tapering (10) exhibits the male thread.

20. The molding according to claim 13 wherein the disk-shaped optical construction element (2) is one of a polarization filter and a UV barrier filter.

21. The molding according to claim 13 wherein the rigid plastic material is a polyamide.

22. A method comprising the steps of:
(A) inserting a disk-shaped optical construction element (2) into an injection mold of an injection molding machine;
(B) fixing the disk-shaped optical construction element (2) in the injection mold using tool elements that contact the disk-shaped optical construction element (2) at its surface sides so that the construction element (2) is exposed at its circumferential surface;
(C) injecting plastic material into a cavity that is surrounded by the injection mold, the tool elements, and the disk-shaped optical construction element (2); and
(D) curing the plastic material to form a one-piece overmolded mounting (3).

23. The method according to claim 22 wherein step (B) comprises the step of:
compensating for unevennesses in the surface sides of the disk-shaped optical construction element (2) with the tool elements.

24. The method according to claim 23 wherein step (B) comprises the steps of:
using the clamping pressure that closes the injection mold after the disk-shaped optical construction element (2) has been inserted: to determine the position of the tool elements contacting the disk-shaped optical construction element (2); and, to arrange the tool elements to compensate for the unevennesses in the surface sides of the optical construction element (2).
